(19) United States
(12) Patent Application Publication
(10) Pub. No.: US 2023/0212912 A1
(43) Pub. Date: Jul. 6, 2023

(54) LATERAL STABILIZING DEVICE FOR WORKING LADDER

(71) Applicant: Chang-I Shih, Tainan City (TW)

(72) Inventor: Chang-I Shih, Tainan City (TW)

(21) Appl. No.: 17/998,809

(22) PCT Filed: Jun. 9, 2020
(86) PCT No.: PCT/CN2020/095125

§ 371 Date: Nov. 15, 2022

(51) Int. Cl. E06C 7/42

(52) U.S. Cl. CPC E06C 7/423

(57) ABSTRACT

A lateral stabilizing device for a working ladder, wherein the working ladder has supporting legs, each supporting leg is configured with a frame holding groove, the bottom side of the supporting leg is fixed with a lateral stabilizing device, the lateral stabilizing device has a rotary connecting seat, the rotary connecting seat is configured with a rotary connecting slot matching the frame holding groove, the rotary connecting slot is plugged with a rotary shaft, the rotary shaft is sheathed with a first main spring and a swing frame, the swing frame is fixed with a ratchet wheel, the periphery of the ratchet wheel is distributed with teeth; the first main spring is fixed with a rotary connecting seat and a ratchet wheel; the top of the ratchet wheel is abutted with a swing component, the swing component is configured with a pawl meshing with the teeth.

### BACKGROUND OF INVENTION

### 1. Field of the Invention

The present invention relates generally to a stabilizing device, and more particularly to a lateral stabilizing device for a working ladder to make the working ladder more stable in use.

### 2. Description of Related Art

Depicted in FIG. 1 is a working ladder 10. When the working ladder 10 is in use, it is supported by the left and right ladder faces 101 in an open state. The user can step on the ladder faces 101 to climb up to a high position for working operations. However, as the ladder faces 101 have a limited width, and most working ladders 10 are made of light-weighted aluminum alloy materials, the working ladders 10 have limited stability in use.

Hence, manufacturers often limit the application range of their working ladders 10. To ensure safety, a user may need a safeguarding assistant to stand by and stable the working ladder 10.

### SUMMARY OF THE INVENTION

In view of the above, the object of the present invention is to provide a lateral stabilizing device for a working ladder, so as to overcome the shortcomings of the existing working ladders, which have poor stability and safety in use.

The present invention provide a lateral stabilizing device for a working ladder, comprising a folding body respectively on left and right sides of the working ladder, a set of supporting leg respectively on front and rear outer sides of the working ladder, an inwardly concave frame holding groove arranged on an outer side of at least one supporting leg, a lateral stabilizing device fixed to a bottom end of the at least one supporting leg, wherein the lateral stabilizing device includes a rotary connecting seat, a rotary connecting slot corresponding to the frame holding groove, and a component hole disposed on an inner side of the rotary connecting slot; a rotary shaft inserted into the rotary connecting slot; a first main spring sleeved on the rotary shaft; a swing frame pivotally connected on the rotary shaft, wherein the swing frame includes a ratchet wheel and teeth distributed around the ratchet; the first main spring is configured with a first positioning terminal disposed on the rotary connecting seat, and a first recovery terminal disposed on the ratchet wheel and forcing the swing frame to be turned upwardly into the frame holding groove; a swing component overlapped above the ratchet wheel, wherein one side of the swing component is provided with a pawl that engages with the teeth, and the other side of the swing component is provided with a disengaging pressing portion extending out of the component hole; a component shaft pivotally connected to the swing component and inserted into the rotary connecting groove; a second main spring sleeved on the component shaft, wherein the second main spring is configured with a second positioning terminal disposed on the rotary connecting seat, and a second recovery terminal to position the swing component to control the pawl to rotate downward to engage with the teeth.

More preferably, wherein the swing frame is pivotally connected with the rotary shaft at a lower end, and an upper end of the swing frame is configured with an anti-slip groove, an anti-slip block is pivotally connected to the anti-slip block groove, and an anti-slip protrusion extending laterally from the anti-slip block.

More preferably, wherein the upper end of the swing frame is configured with a pedal protrusion extending out of the frame holding groove.

The benefit of the present invention is that: the bottom side of the supporting leg is fixed with a lateral stabilizing device, and the lateral stabilizing device uses a first main spring, a ratchet wheel combined with a swing component to control the swing frame, so that, when it is not in use, it can be turned up and be held inside the frame holding groove.

### BRIEF DESCRIPTION OF THE DRAWINGS

FIG. 1 is a schematic view of an existing working ladder.

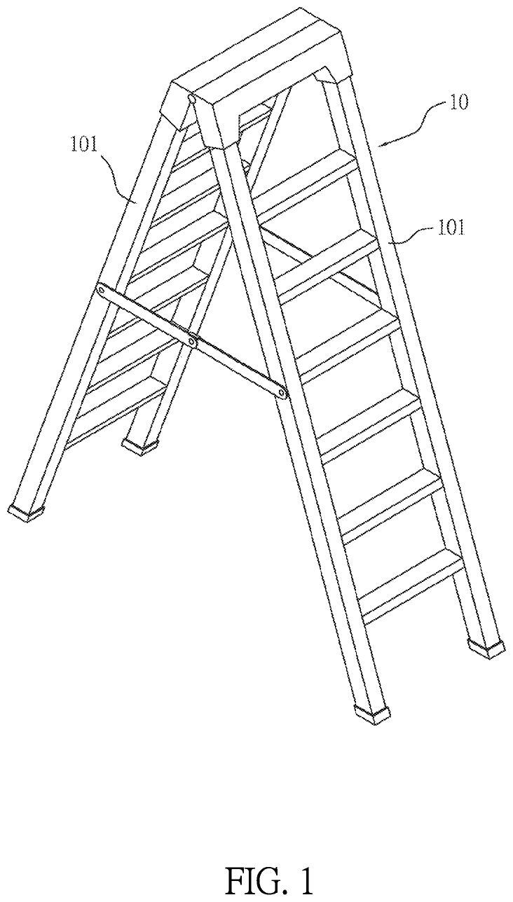

FIG. 2 is a lateral combined view of the working ladder of the present invention;

FIG. 3 is an exploded perspective view of the working ladder of the present invention;

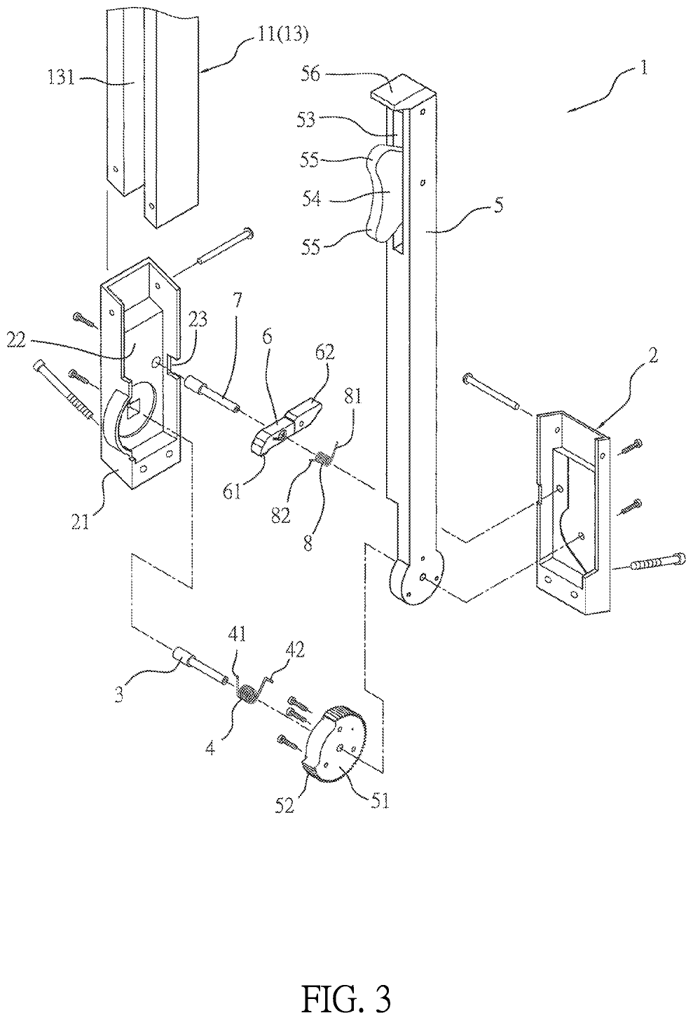

FIG. 4 is a combined view of the lateral stabilizing device of the present invention;

FIG. 5 is a schematic view of the working ladder of the present invention in an open and using state;

FIG. 6 is a schematic view of the lateral stabilizing device of the present invention when it is turned down;

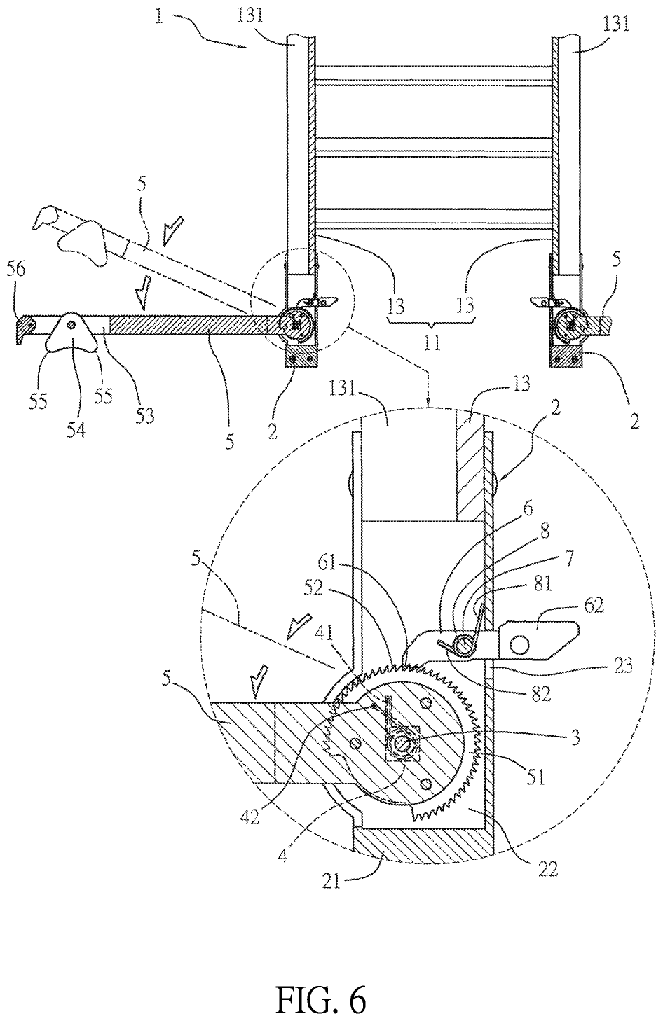

FIG. 7 is a schematic view to show the operation of the pushing position to release the locked state.

### DETAILED DESCRIPTION OF THE INVENTION

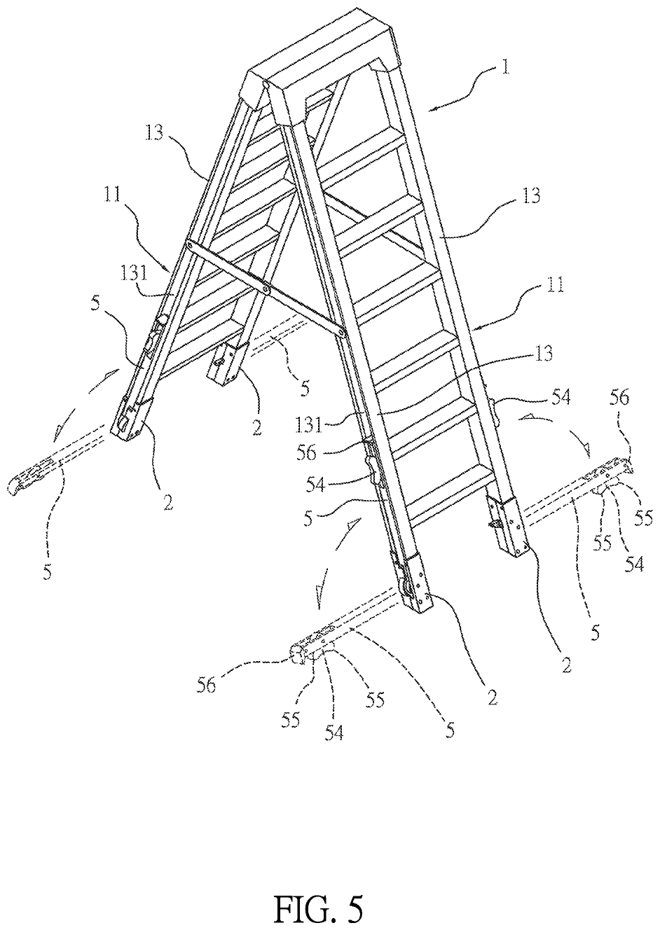

Referring to FIG. —FIG. 5, the present invention provides a lateral stabilizing device 2 of a working ladder 1, wherein, the working ladder 1 has a folding body 11 respectively on the left and right, the folding body 11 has a supporting leg 13 respectively on the front and rear external sides, at least one supporting leg 13 or each of the four supporting legs 13 is configured with a frame holding groove 131 recessed from outside inward, at least one supporting leg 13 or each of the four supporting legs 13 is fixed with a lateral stabilizing device 2 on the bottom side, the lateral stabilizing device 2 has a rotary connecting seat 21, the rotary connecting seat 21 is configured with a rotary connecting slot 22 matching the frame holding groove 131, the rotary connecting slot 22 is configured with a component through hole 23 on the inner side, the rotary connecting slot 22 is plugged with a rotary shaft 3, the rotary shaft 3 is sheathed with a first main spring 4, and is pivoted with a swing frame 5, the swing frame 5 is fixed with a ratchet wheel 51, the periphery of the ratchet wheel 51 is distributed with teeth 52; the first main spring 4 is configured with a first positioning terminal 41 positioned on the rotary connecting seat 21, and a first recovery terminal 42 positioned on the ratchet wheel 51 to force the swing frame 5 to turn upward and be held inside the frame holding groove 131; the top of the ratchet wheel 51 is abutted with a swing component 6, one side of the swing component 6 is configured with a pawl 61 that meshes with the teeth 52, the other side of the swing component 6 is configured with a releasing pushing part 62 that goes out of the component through hole 23; the rotary connecting slot 22 is plugged with a component shaft 7 that is pivoted with the swing component 6, the component shaft 7 is sheathed with a second main spring 8, the second main spring 8 is configured with a second positioning terminal 81 positioned on the rotary connecting seat 21, and a second recovery terminal 82 to position the swing component 6 to control the pawl 61 to rotate downward to mesh with the teeth 52.

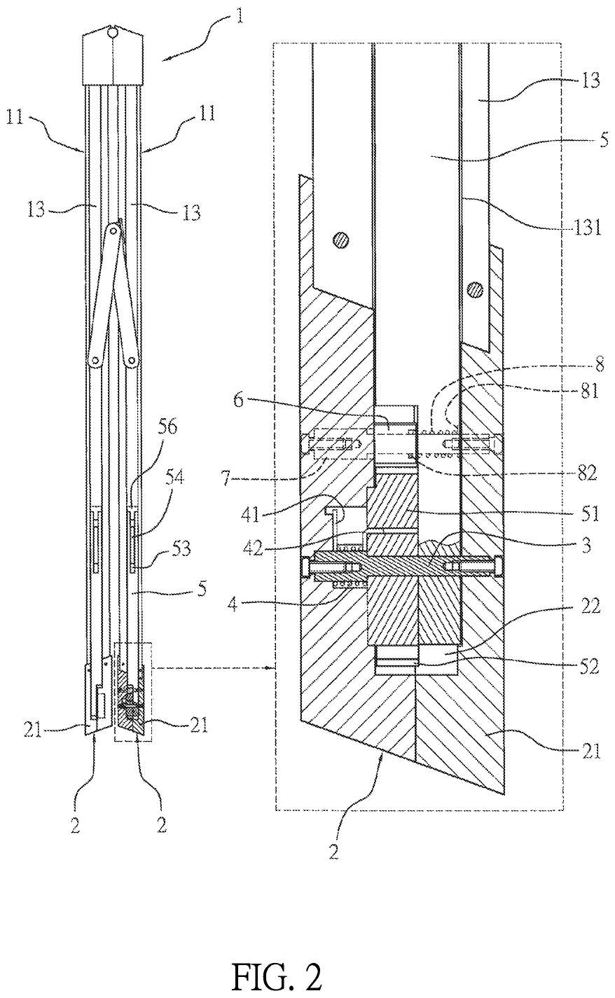

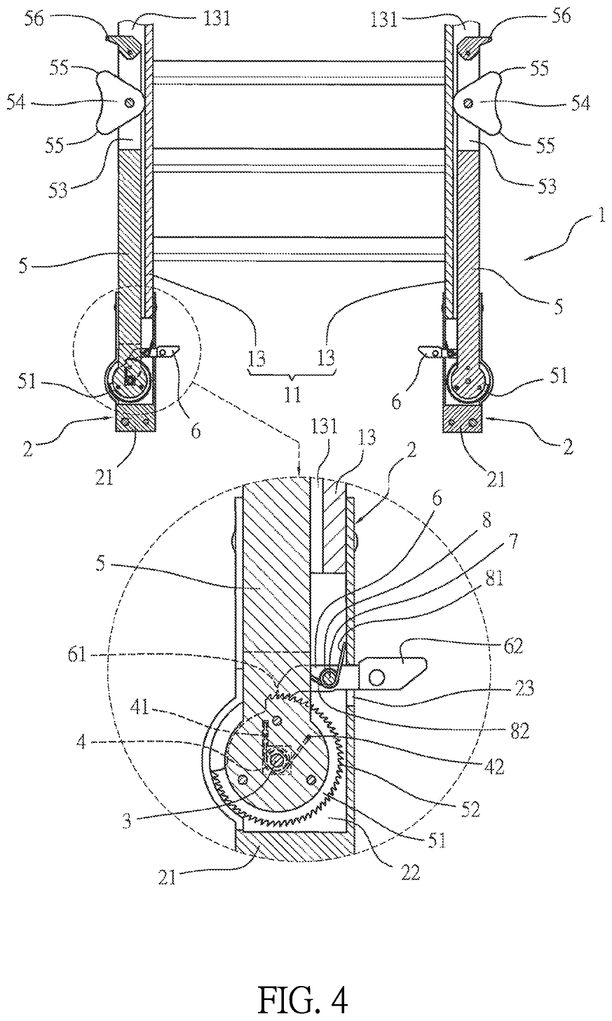

Referring to FIG. 2˜FIG. 4, the swing frame 5 of the present invention is pivoted with a rotary shaft 3 on the lower end, the upper end of the swing frame 5 is further configured with an anti-slip groove 53, the anti-slip groove 53 is pivoted with an anti-slip block 54, the slip stopping block 54 is additionally configured with an anti-slip protrusion 55 protruding laterally. Then, the upper end of the swing frame 5 is also configured with a pedal protrusion 56 extending out of the frame holding groove 131.

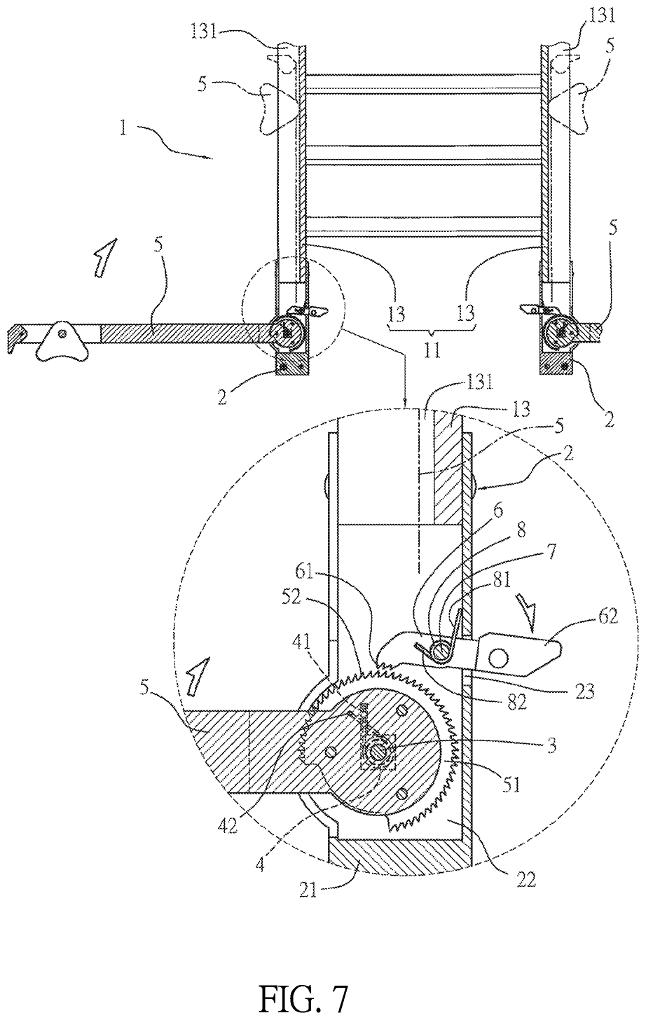

Referring to FIG. 5˜FIG. 7, in the present invention, the bottom side of the supporting leg 13 is fixed with a lateral stabilizing device 2, the lateral stabilizing device 2 uses the first main spring 4, the ratchet wheel 51 combined with a swing component 6 to control the swing frame 5 to turn upward and be held inside the frame holding groove 131 when not in use. To use the working ladder 1 and to enlarge the supporting range, the user can turn the pedal protrusion 56 by hand or by stepping to rotate the swing frame 5 downward. Meanwhile, the ratchet wheel 51 will rotate along with the swing frame 5. The teeth 52 overcome the pawl 61 until the swing frame 5 reaches the expected angle, and are then locked with the pawl 61. The swing frame 5 can be turned to the horizontal position to match the ground, and the slip stopping convex part 55 can be supported on the ground; Moreover, the swing frame 5 can be turned to an appropriate angle to match the ground, and anti-slip protrusion 55 can be supported on the ground. On the contrary, to fold the swing frame 5, the user can simply press down the releasing pushing part 62 to let the pawl 61 move upward to release its meshing with the teeth 52. Meanwhile, the first main spring 4 forces the swing frame 5 to turn upward and be held inside the frame holding groove 131.

To conclude, the lateral stabilizing device 2 of the present invention fixed on the bottom side of the supporting leg 13 uses the first main spring 4 to force the unused swing frame 5 to turn upward and be held inside the frame holding groove 131, and uses the ratchet wheel 51 combined with a swing component 6 to position the swing frame 5 inside the frame holding groove 131. To use the working ladder 1 and to enlarge the supporting range, the user can rotate the pedal protrusion 56 to turn the swing frame 5 downward to an appropriate position. At this time, the swing frame 5 can be turned to an appropriate angle when the teeth 52 of the ratchet wheel 51 overcome the pawl 61 until the appropriate angle and are then locked. On the contrary, to fold the swing frame 5, the user can simply press down the releasing pushing part 62 to let the pawl 61 move upward to release its meshing with the teeth 52.

I claim:

1. A lateral stabilizing device for a working ladder, comprising
a folding body respectively on left and right sides of the working ladder,
a set of supporting leg respectively on front and rear outer sides of the working ladder,
an inwardly concave frame holding groove arranged on an outer side of at least one supporting leg,
a lateral stabilizing device fixed to a bottom end of the at least one supporting leg, wherein the lateral stabilizing device includes a rotary, connecting seat, a rotary connecting slot corresponding to the frame holding groove, and a component hole disposed on an inner side of the rotary connecting slot;
a rotary shaft inserted into the rotary connecting slot;
a first main spring sleeved on the rotary shaft;
a swing frame pivotally connected on the rotary shaft, wherein the swing frame includes a ratchet wheel and teeth distributed around the ratchet; the first main spring is configured with a first positioning terminal disposed on the rotary connecting seat, and a first recovery terminal disposed on the ratchet wheel and forcing the swing frame to be turned upwardly into the frame holding groove;
a swing component overlapped above the ratchet wheel, wherein one side of the swing component is provided with a pawl that engages with the teeth, and the other side of the swing component is provided with a disengaging pressing portion extending out of the component hole;
a component shaft pivotally connected to the swing component and inserted into the rotary connecting groove; and
a second main spring sleeved on the component shaft, wherein the second main spring is configured with a second positioning terminal disposed on the rotary connecting seat, and a second recovery terminal to position the swing component to control the pawl to rotate downward to engage with the teeth.

2. The lateral stabilizing device for the working ladder according to claim 1, wherein the swing frame is pivotally connected with the rotary shaft at a lower end, and an upper end of the swing frame is configured with an anti-slip groove, an anti-slip block is pivotally connected to the anti-slip block groove, and an anti-slip protrusion extending laterally from the anti-slip block.

3. The lateral stabilizing device for the working ladder according to claim 1, wherein the upper end of the swing frame is configured with a pedal protrusion extending out of the frame holding groove.
